(19) United States
(12) Patent Application Publication
(10) Pub. No.: US 2026/0318300 A1
(43) Pub. Date: Oct. 15, 2026

(54) SCROLL COMPRESSOR

(71) Applicant: LG ELECTRONICS INC., Seoul (KR)

(72) Inventors: Jungsun CHOI, Seoul (KR); Byungkil YOO, Seoul (KR); Jehyeon MOON, Seoul (KR); Kyungho LEE, Seoul (KR); Seheon CHOI, Seoul (KR)

(73) Assignee: LG ELECTRONICS INC., Seoul (KR)

(21) Appl. No.: 19/485,486

(22) PCT Filed: Jun. 23, 2023
(86) PCT No.: PCT/KR2023/008754

§ 371 Date: Nov. 18, 2025

(30) Foreign Application Priority Data
May 19, 2023 (KR) 10-2023-0065043

(51) Int. Cl. F04C 18/02

(52) U.S. Cl. CPC F04C 18/0215; F04C 18/0269

(57) ABSTRACT

Abstract: The present disclosure relates to a scroll compressor allowing the wrapped shape of a scroll to be optimally configured to increase compression efficiency and compression volume.

### TECHNICAL FIELD

The present disclosure relates to a scroll compressor. More specifically, the present disclosure relates to a scroll compressor capable of optimally designing a scroll wrap shape to increase compression efficiency and compression volume.

### BACKGROUND

In general, a compressor is an apparatus applied to a refrigeration cycle such as a refrigerator or an air conditioner (hereinafter, simply referred to as the refrigeration cycle), and provides work necessary for heat exchange to occur in the refrigeration cycle by compressing a refrigerant.

The compressors may be classified into a reciprocating type, a rotary type, a scroll type, and the like based on a scheme of compressing the refrigerant. Among these, the scroll compressor is a compressor in which an orbiting scroll is engaged with a fixed scroll fixed in an inner space of a sealed container and performs an orbital motion, thereby defining a compression chamber between a fixed wrap of the fixed scroll and an orbiting wrap of the orbiting scroll.

Because continuous compression is achieved through the scrolls engaged with each other, the scroll compressor may obtain a relatively high compression ratio compared to those of other types of compressors, and may obtain a stable torque as suction, compression, and discharge strokes of the refrigerant are smoothly continued. For this reason, the scroll compressor is widely used for the refrigerant compression in an air conditioning device and the like.

Conventionally, a wrap shape of the scroll compressor has been implemented using a curve such as an involute or a logarithmic spiral. Using a regular mathematical formula such as that of the involute or the logarithmic spiral, a generated error may be minimized even when the wrap is mass-produced, thereby increasing reliability of the compressor.

In one example, as the market for home appliances expands further, the compressors are often used for home appliances used in cold regions with low outside air temperatures. In this case, because it is difficult for the compressor installed in the corresponding region to compress the refrigerant at a compression ratio higher than that in a temperate region, compressor efficiency may not be guaranteed.

In particular, in terms of the refrigerant used in the compressor, regulations recommending use of a refrigerant with a low compression ratio in consideration of environment and stability are increasing.

Accordingly, there is a need for a scroll compressor capable of overcoming the corresponding problem by compressing a greater amount of refrigerant even while having the same volume.

However, the existing scroll compressor having the logarithmic spiral or involute-shaped wrap has a fundamental limitation in that, because an area of an end plate of the orbiting scroll or the like is not able to be fully used, it is impossible to increase a displacement volume in a radial direction of the end plate.

Therefore, the existing compressor has attempted to overcome the corresponding problem by increasing a vertical dimension of the wrap to expand the displacement volume, but this has a fundamental problem in that the refrigerant is not able to be compressed at a high pressure due to durability of the wrap or stability of the wrap is not able to be guaranteed.

In one example, conventionally, there has been an attempt to further expand a length of the orbiting wrap by eccentrically placing a center of the orbiting wrap relative to a center of the end plate of the orbiting scroll, but there is a fundamental problem that vibration and noise are additionally generated when the scroll compressor is operated at a high RPM, or a force and energy are also eccentric, and thus the scroll compressor is not able to be stably operated.

### SUMMARY

### Technical Problem

The present disclosure provides a scroll compressor capable of increasing a displacement volume while maintaining a vertical dimension of a wrap.

The present disclosure increases a displacement volume without eccentrically placing an outlet, from which a refrigerant is discharged, relative to an end plate of an orbiting scroll and an end plate of a fixed scroll toward an outer surface of each plate.

The present disclosure provides a scroll compressor capable of ensuring durability and stability while increasing a displacement volume compared to an end plate area size of an orbiting scroll.

The present disclosure provides a scroll compressor having a wrap shape capable of increasing a displacement volume in a direction of an outer surface of an end plate of an orbiting scroll.

### Technical Solutions

In order to solve the above-described problems, the present disclosure may mix a different mathematical formula such as that of an arc with an existing mathematical formula such as that of an involute or a logarithmic spiral for defining a scroll shape, thereby enabling a maximum outer-diameter portion of an orbiting scroll end plate to be utilized as a compression space. As a result, a displacement volume may be increased without increasing a wrap vertical dimension while maintaining the same frame diameter.

In order to solve the above-described problems, the present disclosure may allow various application of wrap mathematical formulas and sections for determining a wrap thickness, and even enable mathematical formulas for an outer path (a path A) of the wrap and an inner path (a path B) thereof to be set differently, thereby allowing a wrap thickness in a desired section to be freely designed.

In order to solve the above-described problems, the present disclosure provides a compressor including: a casing; a fixed scroll including: a fixed end plate coupled to the casing and including an inlet that sucks a refrigerant and an outlet that is disposed inwardly of the inlet and discharges the refrigerant; and a fixed wrap extending from the fixed end plate in a direction from the inlet to the outlet; and an orbiting scroll including: an orbiting end plate disposed to face the fixed plate; and an orbiting wrap that extends from the orbiting end plate to face the fixed wrap and compresses the refrigerant, wherein a thickness or a shape of the orbiting wrap is different from a thickness or a shape of the fixed wrap facing the orbiting wrap.

The orbiting wrap may be formed thicker than the fixed wrap.

The orbiting wrap may become thicker while extending from the inlet to the outlet.

The orbiting wrap may become thicker while extending from the inlet to the outlet.

A spacing between adjacent portions of the orbiting wrap disposed in a first area, corresponding to a 90-degree range about the rotation shaft from an outermost end of the orbiting wrap facing the inlet, may be set to be greater than a spacing between adjacent portions of the orbiting wrap disposed in other areas.

Spacings between respective pairs of adjacent portions of the orbiting wrap disposed in a second area, corresponding to a side opposite the first area with respect to the rotation shaft, may be equal to each other.

A spacing between adjacent portions of the fixed wrap facing the adjacent portions of the orbiting wrap disposed in the first area may be set to be greater than a spacing between adjacent portions of the fixed wrap disposed in other areas.

Spacings between respective pairs of adjacent portions of the fixed facing the respective pairs of adjacent portions of the orbiting wrap disposed in the second area may be equal to each other.

The orbiting wrap may extend from an outermost end thereof facing the inlet to an innermost end thereof facing the outlet, and may have a shape formed by a combination of an arc and a logarithmic spiral.

The orbiting wrap may extend in the arc shape from the outermost end thereof and then extend in the logarithmic spiral shape.

The orbiting wrap may extend from the outermost end thereof in the arc shape over 180 degrees with respect to the rotation shaft, and then extend in the logarithmic spiral shape over 90 degrees or more with respect to the rotation shaft.

The orbiting wrap may extend from the outermost end thereof in the arc shape over 180 degrees with respect to the rotation shaft, and extend in the logarithmic spiral shape in other areas.

A spacing between adjacent portions of the orbiting wrap disposed in a first area, defined within a 90-degree range about the rotation shaft from an outermost end of the orbiting wrap adjacent to the inlet, may be different from at least one of: a spacing between adjacent portions of the orbiting wrap disposed in a third area, defined within a 90-degree range about the rotation shaft from a distal end of the first area; a spacing between adjacent portions of the orbiting wrap disposed in a second area, defined within a 90-degree range about the rotation shaft from a distal end of the third area; and a spacing between adjacent portions of the orbiting wrap disposed in a fourth area, defined between a distal end of the second area and the first area.

The spacing between the adjacent portions of the orbiting wrap disposed in the first area, defined within the 90-degree range about the rotation shaft from the outermost end of the orbiting wrap adjacent to the inlet, the spacing between the adjacent portions of the orbiting wrap disposed in the third area, defined within the 90-degree range about the rotation shaft from the distal end of the first area, the spacing between the adjacent portions of the orbiting wrap disposed in the second area, defined within the 90-degree range about the rotation shaft from the distal end of the third area, and the spacing between the adjacent portions of the orbiting wrap disposed in the fourth area, defined between the distal end of the second area and the first area may all be different from each other.

The spacing between the adjacent portions of the orbiting wrap disposed in the first area may be greater than the spacing between the adjacent portions of the orbiting wrap disposed in the third area, and the spacing between the adjacent portions of the orbiting wrap disposed in the third area may be greater than the spacing between the adjacent portions of the orbiting wrap disposed in the second area.

### Advantageous Effects

The present disclosure provides the scroll compressor capable of increasing the displacement volume while maintaining the vertical dimension of the wrap.

The present disclosure increases the displacement volume without eccentrically placing the outlet, from which the refrigerant is discharged, relative to the end plate of the orbiting scroll and the end plate of the fixed scroll toward the outer surface of each plate.

The present disclosure provides the scroll compressor capable of ensuring the durability and the stability while increasing the displacement volume compared to the end plate area size of the orbiting scroll.

The present disclosure provides the scroll compressor having the wrap shape capable of increasing the displacement volume in the direction of the outer surface of the end plate of the orbiting scroll.

### BRIEF DESCRIPTION OF THE DRAWINGS

FIG. 1 illustrates a basic structure of a scroll compressor according to the present disclosure.

FIG. 2 illustrates a detailed structure of the compression mechanism 300.

FIG. 3 illustrates detailed shapes of the orbiting scroll and the fixed scroll.

FIG. 4 illustrates an embodiment in which a fixed wrap and an orbiting wrap are designed.

FIG. 5 illustrates an embodiment in which the orbiting wrap and the fixed wrap are actually designed based on the envelope curves.

FIG. 6 illustrates a first embodiment of a wrap design scheme of a scroll compressor according to the present disclosure.

FIG. 7 illustrates a second embodiment of a wrap design scheme of a scroll compressor according to the present disclosure.

FIG. 8 illustrates a third embodiment of a wrap design scheme of a scroll compressor according to the present disclosure.

FIG. 9 illustrates a fourth embodiment of a wrap design scheme of a scroll compressor according to the present disclosure.

FIG. 10 illustrates a fifth embodiment of a wrap design scheme of a scroll compressor according to the present disclosure.

FIG. 11 illustrates a sixth embodiment of a wrap design scheme of a scroll compressor according to the present disclosure.

### BEST MODEL

Hereinafter, embodiments disclosed in the present document will be described in detail with reference to the accompanying drawings. In the present document, the same or similar reference numerals will be assigned to the same or similar components even in different embodiments, and a description thereof will be substituted by a first description. A singular expression used herein includes a plural expression, unless the context clearly indicates otherwise. In addition, in describing the embodiments disclosed herein, when it is determined that a detailed description of a related known technology may obscure the gist of the embodiments disclosed herein, the detailed description thereof will be omitted. In addition, it should be noted that the accompanying drawings are only for making it easy to understand the embodiments disclosed herein, and the technical idea disclosed herein should not be interpreted as being limited by the accompanying drawings.

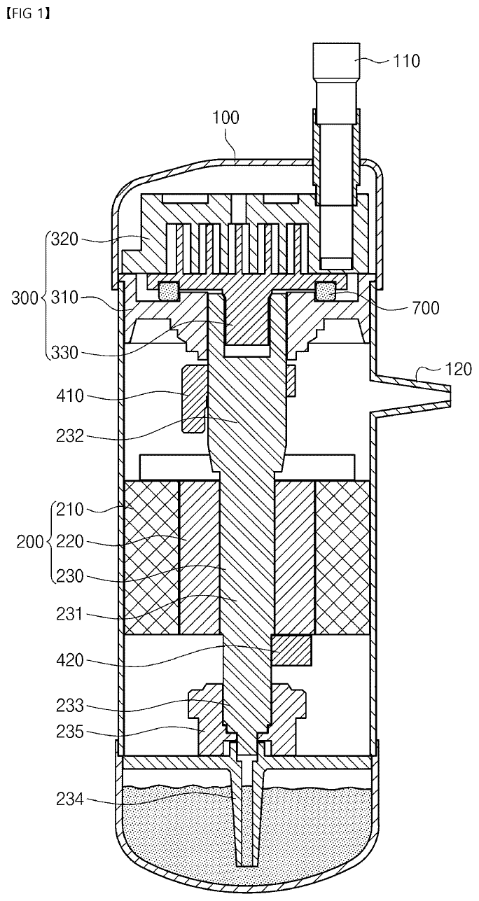

FIG. 1 illustrates a basic structure of a scroll compressor according to the present disclosure.

The scroll compressor according to the present disclosure may be generally installed in an apparatus using a heat pump system, and may be configured to receive a fluid such as a refrigerant, compress the same, and discharge the same.

For example, the scroll compressor according to the present disclosure may be used in home appliances such as a refrigerator, an air conditioner, and a laundry treating apparatus.

The scroll compressor according to the present disclosure may include a casing 100 forming an outer appearance thereof, a driver 200 coupled to the casing 100, a compression mechanism 300 that receives power from the driver 200 and compresses the fluid, and a balancer 400 that is coupled to the driver 200 and offsets energy resulted from eccentricity.

The casing 100 may be formed in a cylindrical shape, and may include an inflow pipe 110 through which the refrigerant is introduced and a discharge pipe 120 through which the refrigerant, which has been compressed at a high temperature and a high pressure, is discharged.

The casing 100 may have a space, in which oil capable of lubricating one or more of the driver 200 and the compression mechanism 300 is stored, defined at one side thereof.

The oil may be stored at a position closer to the driver 200 than to the compression mechanism 300.

The driver 200 may include a stator 210 that is fixed to an inner wall of the casing 100 and forms a rotating magnetic field, a rotor 220 that rotates by the stator 210, and a rotation shaft 230 that is coupled to the rotor 220 and rotates together with the rotor 220.

The rotation shaft 230 may be longer than the rotor 220 and the stator 210. One end of the rotation shaft 230 may be coupled or connected to the compression mechanism 300, and the other end thereof may extend toward the space in which the oil is stored.

The rotation shaft 230 may include a main shaft 231 coupled to the rotor 220, a coupling shaft 232 extending from the main shaft 231 and connected to the compression mechanism 300, and an extension shaft 233 extending from the main shaft 231 to the oil storage space.

The rotation shaft 230 may further include an oil flow channel for guiding the oil introduced from the extension shaft 233 to the main shaft 231 and the coupling shaft 232, and a communication hole in communication with the oil flow channel, the driver 200, and the compression mechanism 300.

The scroll compressor according to the present disclosure may include a support frame 235 rotatably supporting the extension shaft 233, and a guide 234 that is coupled to the support frame 235 and guides the oil collected in the oil storage space to the extension shaft 233.

The guide 234 may be equipped with an oil pump or the like, or may be in communication with the oil flow channel. Accordingly, the oil accommodated in the oil storage space may be supplied to the driver 200 and the compression mechanism 300 along the oil flow channel.

The oil may lubricate or cool the driver 200 and the compression mechanism 300 The coupling shaft 232 may be eccentric relative to the main shaft 231. For example, the coupling shaft 232 may have a greater diameter than the main shaft 231, and a center of the coupling shaft 232 may be disposed to be spaced apart from a center of the main shaft 231 in a radial direction.

Accordingly, when the rotation shaft 230 rotates, the configuration of the compression mechanism 300 coupled to the coupling shaft 232 may orbit with an orbiting radius corresponding to a distance at which the center of the coupling shaft 232 is eccentric relative to the center of the main shaft 231.

The balancer 400 may include a main balancer 410 coupled to the coupling shaft 232 so as to compensate for the eccentricity of the coupling shaft 232 relative to the main shaft 231, and a compensation balancer 420 coupled to the rotor 220 so as to compensate for eccentricity between the main balancer 410 and the rotation shaft 230.

The compression mechanism 300 may include a fixed scroll 320 that receives the refrigerant supplied from the inflow pipe 110, an orbiting scroll 330 that is engaged with the fixed scroll 320 and is coupled to the rotation shaft 230 to move, and a main frame 310 coupled to the fixed scroll 320 and accommodating the orbiting scroll 330 therein.

The main frame 310 may be coupled to an inner circumferential surface of the casing 100, and have a space defined therein with one surface on which the orbiting scroll 330 is disposed.

An Oldham ring 700 may be disposed between the main frame 310 and the orbiting scroll 330 to prevent the orbiting scroll 330 from rotating about the rotation shaft.

The Oldham ring 700 may be coupled to both the main frame 310 and the orbiting scroll 330. The orbiting scroll 330 may only orbit about the rotation shaft 230 and be prevented from spinning or rotating about the rotation shaft 230, by the Oldham ring 700.

The orbiting scroll 330 may rotatably support the coupling shaft 232. The orbiting scroll 330 may not rotate together with the coupling shaft 232, but may support the coupling shaft 232 like a bearing such that the coupling shaft 232 may rotate relatively. As a result, the orbiting scroll 330 may not rotate together with the coupling shaft 232, but may orbit because of the eccentricity of the coupling shaft 232.

The fixed scroll 320 may be in communication with the inflow pipe 110 and receive the refrigerant. A compression space in which the refrigerant is compressed may be defined between the orbiting scroll 330 and the fixed scroll 320, and the refrigerant introduced into the inflow pipe 110 may be compressed and flow while the orbiting scroll 330 orbits.

The fixed scroll 320 may include a discharge portion through which the compressed refrigerant is discharged.

Remaining areas of the fixed scroll 320 excluding an outer circumferential surface may be spaced apart from the inner surface of the casing 100. That is, the discharge portion may be disposed to be spaced apart from the casing 100 by a predetermined spacing. Accordingly, the refrigerant may be discharged from the fixed scroll 320 and flow into the casing 100, and the refrigerant discharged from the fixed scroll 320 may be discharged to the discharge pipe 120 coupled to the casing 100.

The refrigerant discharged from the fixed scroll 320 may be in a high pressure state, and the high-pressure refrigerant may maintain the inside of the casing 100 at the high pressure until it is discharged to the discharge pipe 120.

As a result, the oil stored in the casing 100 may flow along the oil flow channel by a pressure difference, and be discharged to a plurality of communication holes to be supplied to the driver 200 and the compression mechanism 300. The oil may not be vaporized in the compression mechanism 300, but may be discharged together with the refrigerant and collected again into the oil storage space along the inner wall of the casing 100.

The discharge pipe 120 may be disposed between the compression mechanism 300 and the driver 200, but may be disposed at any position of the casing 100 as long as the refrigerant discharged from the fixed scroll 320 may be discharged.

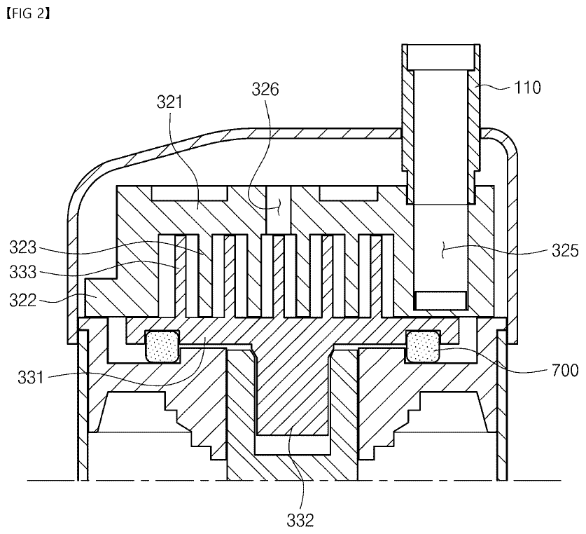

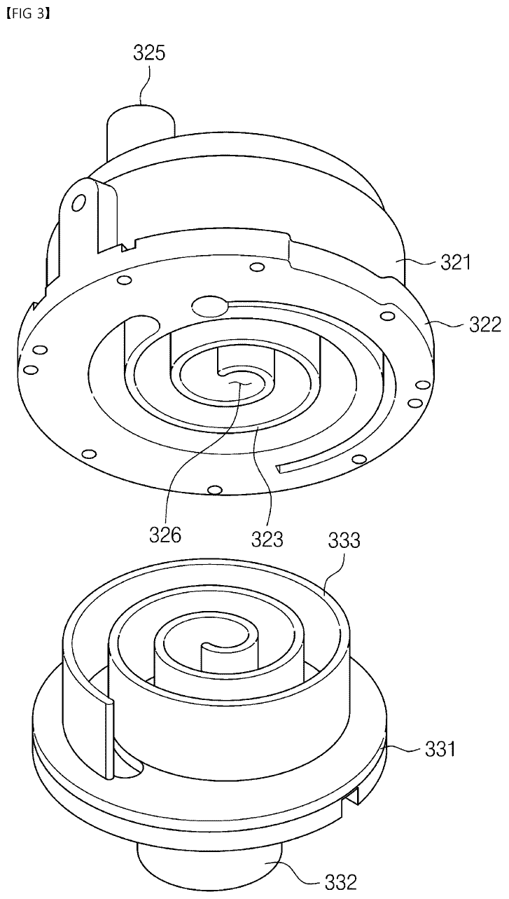

FIG. 2 illustrates a detailed structure of the compression mechanism 300, and FIG. 3 illustrates detailed shapes of the orbiting scroll and the fixed scroll.

The fixed scroll 320 may include a fixed end plate 321 that is in communication with the inflow pipe 110 and receives the refrigerant, a coupling plate 322 extending from an outer circumferential surface of the fixed end plate 321 and coupled to the inner surface of the casing 100, and a fixed wrap 323 protruding from the fixed end plate 321 to compress the refrigerant.

The fixed end plate 321 may include an inlet 325 that is in communication with the inflow pipe 110 and receives the refrigerant, and an outlet 326 that is defined inwardly of the inlet 325 and discharges the refrigerant.

The outlet 326 may be defined at a center of the fixed end plate 321, and may extend through the fixed end plate 321 from an inner side of the fixed end plate 321 in a direction away from the driver 200.

The inlet 325 may be defined closer to the outer circumferential surface of the fixed end plate 321 than the outlet 326.

The fixed wrap 323 may protrude from one surface of the fixed end plate 321 to have the same vertical dimension as the coupling plate 322, and may extend from the inlet 325 toward the outlet 326 along a circumferential direction of the fixed end plate 321.

The fixed wrap 323 may be formed in at least one of logarithmic spiral, involute, and arc shapes to be described later. The fixed wrap 323 may be considered to be formed in a vortex shape.

The fixed coupling plate 322 may extend outwardly of the fixed end plate 321. A diameter of the fixed coupling plate 322 may be greater than a diameter of the fixed end plate 321. The diameter of the fixed coupling plate 322 may correspond to a diameter of the inner circumferential surface of the casing 100.

At least one bypass hole may be defined in the fixed coupling plate 322 in a direction of the rotation shaft. As a result, even when the fixed coupling plate 322 is in surface contact with the inner circumferential surface of the casing 100, the refrigerant discharged from the discharge hole 326 may be discharged to the discharge pipe 120.

The orbiting scroll 330 may include an orbiting end plate 331 disposed in parallel with the fixed end plate 321, an orbiting wrap 333 protruding from the orbiting end plate 331 in a direction to be engaged with or facing the fixed wrap 323, and a journal portion 332 extending from the orbiting end plate 331 and rotatably supporting the rotation shaft 230.

The orbiting end plate 331 may have a diameter equal to or smaller than that of the fixed end plate 321, and the orbiting wrap 333 may have a vertical dimension corresponding to that of the fixed wrap 323.

The orbiting wrap 333 may extend along a circumferential direction of the orbiting end plate 331 so as to be engaged with or face the fixed wrap 323. As a result, the orbiting wrap 333 may also extend from the inlet 325 toward the outlet 326 while decreasing in diameter in the circumferential direction of the orbiting end plate 331. As a result, the orbiting wrap 333 may also be formed in the vortex shape.

The journal portion 332 may be formed in any shape as long as it may receive a pressurizing force in the radial direction by the coupling shaft 232 while rotatably supporting the rotation shaft 230.

The journal portion 332 may have a smaller diameter than the coupling shaft 232 and may be accommodated in the coupling shaft 232.

In this case, the coupling shaft 232 may be eccentric relative to the main shaft 231, but the coupling shaft 232 may not be eccentric relative to the main shaft 231, and the journal portion 332 accommodated in the coupling shaft 232 may be eccentrically accommodated in the coupling shaft 232.

In one example, the coupling shaft 232 may be eccentric relative to the main shaft 231, and the journal portion 332 may protrude from the orbiting end plate 331 with a center thereof aligned with that of the coupling shaft 232.

The main frame 310 may be seated on the fixed coupling plate 322, be coupled to the casing 100, and accommodate the orbiting scroll 330 therein.

The orbiting scroll 330 may be disposed between the main frame 310 and the fixed scroll 320 and orbit about the rotation shaft 230.

For the orbiting wrap 333 and the fixed wrap 323 to continuously compress the refrigerant without outflow, the orbiting end plate 321 should be prevented from rotating about the rotation shaft. To this end, the Oldham ring 700 may be equipped as a rigid body and disposed between the orbiting scroll 330 and the main frame 310.

The Oldham ring 700 may be coupled to the orbiting end plate 321 so as to slide in a reciprocating manner in a first direction, and may be coupled to the main frame 310 so as to slide in a reciprocating manner in a second direction different from the first direction. For example, the second direction may be perpendicular to the first direction.

Accordingly, the orbiting scroll 330 may only have a center thereof orbiting about the rotation shaft based on a movement allowed by the Oldham ring 700, and may be prevented from rotating by itself.

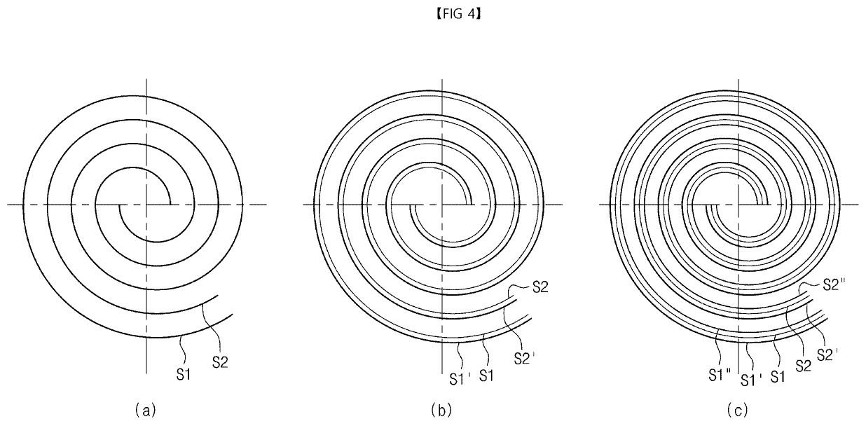

FIG. 4 illustrates an embodiment in which a fixed wrap and an orbiting wrap are designed.

The fixed wrap and the orbiting wrap should be designed such that the refrigerant may be continuously compressed without flowing out. In addition, because an inner surface and an outer surface of the orbiting wrap are engaged respectively with an outer surface and an inner surface of the fixed wrap, separate compression chambers are defined between the respective pairs of engaged surfaces.

For example, based on the orbiting wrap 333, a first compression chamber S1 in which the refrigerant is compressed is present between the outer surface of the orbiting wrap 333 and the inner surface of the fixed wrap 323, and a second compression chamber S2 in which the refrigerant is compressed is present between the inner surface of the orbiting wrap 333 and the outer surface of the fixed wrap 323. The first compression chamber S1 and the second compression chamber S2 are separated from each other and are not in communication with each other. The refrigerant introduced from the inlet 325 may be distributed to the first compression chamber S1 and the second compression chamber S2, continuously compressed, and discharged toward the outlet 326.

Envelope curves may be formed in a direction in which the refrigerant flows in the first compression chamber S1 and the second compression chamber S2, and the shapes of the orbiting wrap and the fixed wrap may be designed around the envelope curves. The envelope curves refer to trajectories respectively drawn by the first compression chamber S1 and the second compression chamber S2 while they gradually move from the inlet 325 to the outlet 326 based on the orbital motion of the orbiting scroll 330. When translating each envelope curve outwards and inwards by an amount corresponding to an orbiting radius of the orbiting scroll, shapes of the inner surface of the fixed wrap and the outer surface of the orbiting wrap or the outer surface of the fixed wrap and the inner surface of the orbiting wrap may be formed.

Referring to (a) in FIG. 4, a pair of envelope curves defining the first compression chamber SI and the second compression chamber S2 may be designed. In this regard, an envelope curve corresponding to the first compression chamber S1 may be defined as a first envelope curve S1, and an envelope curve corresponding to the second compression chamber S2 may be defined as a second envelope curve S2.

Referring to (b) in FIG. 4, a first outer envelope curve S1′ and a second outer envelope curve S2′ may be respectively designed by outwardly offsetting the first envelope curve S1 and the second envelope curve S2 by a length corresponding to the orbiting radius formed when the orbiting scroll 330 spins.

Referring to (c) in FIG. 4, a first inner envelope curve S1″ and a second inner envelope curve S2″ may be respectively designed by inwardly offsetting the first envelope curve S1 and the second envelope curve S2 by a length corresponding to the orbiting radius generated when the orbiting scroll 330 spins.

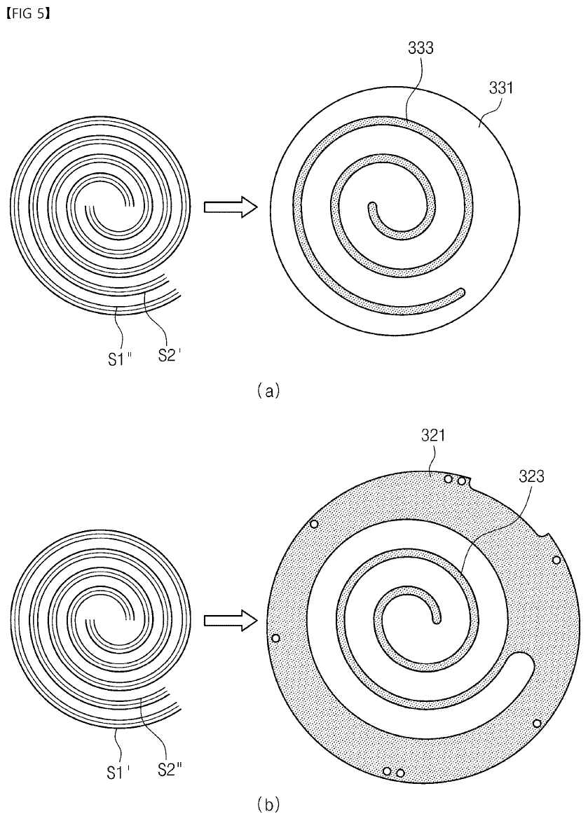

FIG. 5 illustrates an embodiment in which the orbiting wrap and the fixed wrap are actually designed based on the envelope curves.

In the scroll compressor according to the present disclosure, in designing the orbiting wrap and the fixed wrap, both an outermost end of the orbiting wrap and an outermost end of the fixed wrap may be disposed adjacent to the inlet 325, and both an innermost end of the orbiting wrap and an innermost end of the fixed wrap may be disposed adjacent to the outlet 326.

In addition, because the rotation shaft is not accommodated in or does not extend through one surface of the orbiting end plate 331 from which the orbiting wrap 333 protrudes, the orbiting wrap 333 may be designed without being affected by the rotation shaft.

Referring to (a) in FIG. 5, the shape and a thickness of the orbiting wrap 333 may be determined by extending the first inner envelope curve S1″ and the second outer envelope curve S2′.

Referring to (b) in FIG. 5, the shape and a thickness of the fixed wrap 323 may be determined by extending the first outer envelope curve S1′ and the second inner envelope curve S2″.

As such, when the first envelope curve S1 and the second envelope curve S2 are determined, the shapes and the thicknesses of the fixed wrap 323 and the orbiting wrap 333 may be automatically determined accordingly.

In general, the first envelope curve SI and the second envelope curve S2 are lines for tracking the flow of the refrigerant in surface contact therewith, and may be designed identically based on a specific rule, mathematical formula, or figure. That is, the first envelope curve S1 and the second envelope curve S2 may have different curvature radii with respect to each point, but may be entirely designed by the same rule and mathematical formula, and may be formed in shapes corresponding to each other. For example, the first envelope curve S1 and the second envelope curve S2 may be designed in one of arc, logarithmic spiral, and involute shapes. In this case, because entire areas of the first envelope curve S1 and the second envelope curve S2 or areas thereof at least facing each other are formed based on the same rule, spacings, shapes, and thicknesses of the orbiting wrap 333 and the fixed wrap 323 facing each other may correspond to each other.

However, when the first envelope curve S1 and the second envelope curve S2, which are reference for designing the orbiting wrap 333 and the fixed wrap 323, are designed in only one of the arc, logarithmic spiral, and involute shapes, the orbiting wrap 333 and the fixed wrap 323 may be entirely formed in a stable and regular manner, but a sufficient displacement volume may not be secured.

In other words, when the orbiting wrap 333 and the fixed wrap 323 are entirely formed in the same rule and shape, effective radius of the wraps rapidly decreases as they extend from the inlet 325 to the outlet 326. As a result, the displacement volume may also be reduced as the orbiting wrap 333 extends from the inlet 325 to the outlet 326. In addition, considering that the refrigerant becomes more strongly compressed as the displacement volume decreases, when the orbiting wrap 333 is designed such that the radius of curvature thereof is further reduced in order to increase durability, the displacement volume may be further reduced.

Furthermore, as the effective radius of the orbiting wrap 333 decreases as the orbiting wrap 333 extends from the inlet 325 to the outlet 326, an area of the orbiting end plate 331 located adjacent to an outermost side of the orbiting wrap 333 becomes correspondingly wider. As a result, an area of the orbiting end plate 331 that does not participate in the compression may further increase.

Such a wrap design scheme is acceptable when the compressor is used to compress a relatively small amount of refrigerant. However, when it is difficult to secure a performance coefficient (COP) of a heat pump system because the compressor is used in cold regions, or when it is necessary to use a refrigerant having a low heat transfer rate due to environmental problems, there is a problem in that the volume of the compression mechanism 300 is increased or the vertical dimension of the fixed wrap 323 and the orbiting wrap 333 is increased. In this case, although the performance of the compressor may be maintained, the reliability and the durability of the compressor may not be guaranteed, and specifications of the compressor may be changed, and thus the corresponding compressor may not be installed in a product requiring the same.

In addition, a scheme of excessively increasing the RPM of the driver 200 may be applied to the existing compressor. However, in this case, because the refrigerant is excessively compressed, durability of a center of the compression mechanism 300 may not be guaranteed. Further, as a temperature difference between a sucked refrigerant and a discharged refrigerant further increases, thermal expansion rates at inner and outer ends of the orbiting wrap and the fixed wrap may further increase, which may result in deformation and damage.

Therefore, the scroll compressor according to the present disclosure may variously change the design of the envelope curves of the first compression chamber S1 and the second compression chamber S2 so as to expand the displacement volume while maintaining the specifications of the corresponding compressor or to ensure the stability of the orbiting wrap and the fixed wrap. For example, in the scroll compressor according to the present disclosure, the first compression chamber S1 and the second compression chamber S2 may be designed by different mathematical formulas and rules.

In addition, in the scroll compressor according to the present disclosure, even though the shapes of the envelope curves of the first compression chamber S1 and the second compression chamber S2 are maintained, a thickness of at least a portion of the orbiting wrap 333 and the fixed wrap 323 may be variably changed to increase the displacement volume or expand the durability of the orbiting wrap 333 and the fixed wrap 323.

As a result, the scroll compressor according to the present disclosure may perform one of the change in the first envelope curve S1 and the second envelope curve S2 and the change in the thickness of at least the portion of at least one of the orbiting wrap and the fixed wrap. A result of such changes may become visually apparent, in that at least one of the thickness and the shape of the orbiting wrap 333 and at least one of the thickness and the shape of the fixed wrap facing the orbiting wrap differ from their respective states prior to the change.

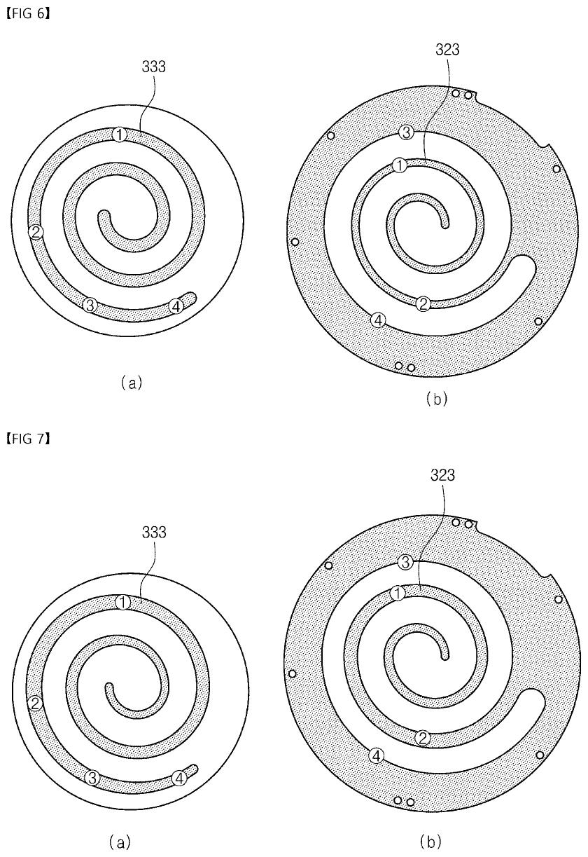

FIG. 6 illustrates a first embodiment of a wrap design scheme of a scroll compressor according to the present disclosure.

(a) in FIG. 6 illustrates a shape of an orbiting wrap in the first embodiment, and (b) in FIG. 6 illustrates a shape of a fixed wrap in the first embodiment.

In the scroll compressor according to the present disclosure, the orbiting wrap 333 may be formed thicker than the fixed wrap 323.

For example, the thickness of the orbiting wrap 333 may not be significantly changed along a first portion, a second portion, a third portion, and a fourth portion, which are defined in a direction from the inner outlet 326 to the outer inlet 325, but all of these portions may have thicknesses greater than those of a first portion, a second portion, a third portion, and a fourth portion of the fixed wrap 323 respectively facing them. In one example, when the fourth portion of the fixed wrap 323 corresponds to the fixed end plate or the coupling plate, the thickness of the fourth portion of the orbiting wrap 333 may be smaller than the thickness of the fourth portion of the fixed wrap 323.

The orbiting wrap 333 may be thicker than the fixed wrap 323 in all areas. Accordingly, the durability of the entire orbiting wrap 333 may be guaranteed, so that the refrigerant may be more strongly compressed. In addition, even when the diameter or the radius of curvature of the entire orbiting wrap 333 is further expanded, rigidity of the orbiting wrap 333 may be maintained, and thus the displacement volume may be expanded.

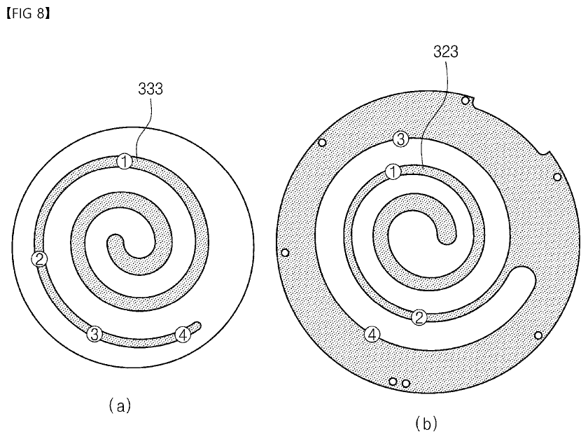

FIG. 7 illustrates a second embodiment of a wrap design scheme of a scroll compressor according to the present disclosure.

(a) in FIG. 7 illustrates a shape of an orbiting wrap in the second embodiment, and (b) in FIG. 7 illustrates a shape of a fixed wrap in the second embodiment.

In the compression mechanism 300, because a portion adjacent to the outlet 326 has a higher pressure than a portion adjacent to the inlet 325, the greater the volume, the greater amount of refrigerant may be maintained in the compressed state.

Accordingly, in the scroll compressor according to the present disclosure, the orbiting wrap 333 may have a thickness at the innermost end thereof adjacent to the outlet 326 smaller than a thickness at the outermost end thereof adjacent to the inlet 325.

Accordingly, a greater amount of refrigerant may be accommodated in the area adjacent to the outlet 326, thereby increasing the displacement volume.

For example, the thickness of the orbiting wrap 333 may gradually decrease as the orbiting wrap 333 extends from the inlet 325 to the outlet 326.

In addition, the orbiting wrap 333 may have a small thickness only in an area, which is defined inwardly of the first portion and surrounds the outlet 326, and may have a uniform thickness in other portions.

The fixed wrap 323 may be formed to have a shape and a thickness corresponding to those of the orbiting wrap 333, or may maintain a uniform thickness unlike as illustrated. In this case, a rapid decrease in the volume of the compression chamber may be compensated for, and the durability of the fixed wrap 323 may also be guaranteed.

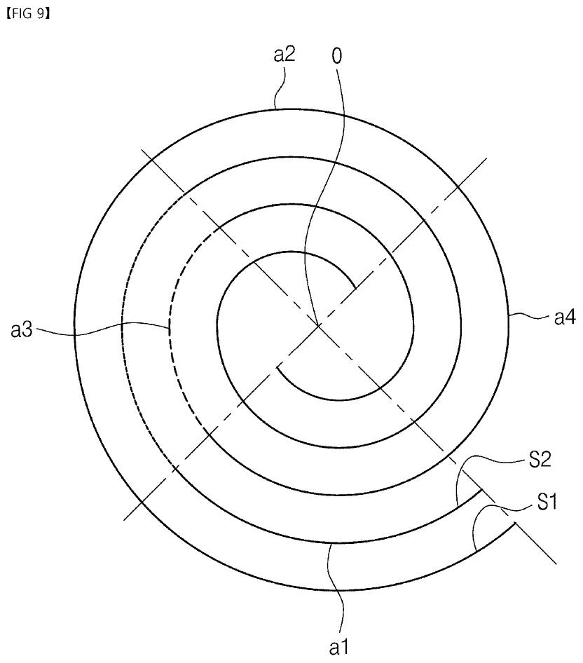

FIG. 8 illustrates a third embodiment of a wrap design scheme of a scroll compressor according to the present disclosure.

(a) in FIG. 8 illustrates a shape of an orbiting wrap in the third embodiment, and (b) in FIG. 8 illustrates a shape of a fixed wrap in the third embodiment.

Regardless of the shape of the orbiting wrap 333, the smaller the thickness of an area of the orbiting wrap 333 facing the inlet 325 is, the greater amount of refrigerant may be sucked into the compression chamber. However, when a thickness of an area thereof facing or adjacent to the outlet 326 is small, a greater displacement volume may be secured, but a problem may occur in the durability.

Therefore, in order to compensate for such a problem, the orbiting wrap 333 of the scroll compressor according to the present disclosure may be constructed such that the thickness of the area thereof facing or adjacent to the outlet 326 is greater than the thickness of the area thereof facing or adjacent to the inlet 325. That is, the innermost end of the orbiting wrap 333 may be thicker than the outermost end thereof.

For example, the orbiting wrap 333 may be constructed such that the thickness thereof gradually increases as the orbiting wrap 333 extends from the inlet 325 to the outlet 326, or may be constructed to be thick starting from the portion thereof defined inwardly of the first portion.

The fixed wrap 323 may be formed in the same manner as the orbiting wrap 333.

For example, the fixed wrap 323 may be constructed such that a thickness of an area thereof facing or adjacent to the outlet 326 is greater than a thickness of an area thereof facing or adjacent to the inlet 325. That is, the innermost end of the fixed wrap 333 may be thicker than the outermost end thereof.

For example, the fixed wrap 323 may be constructed such that the thickness thereof gradually increases as the fixed wrap 323 extends from the inlet 325 to the outlet 326, or may be constructed to be thick starting from a portion thereof defined inwardly of the first portion.

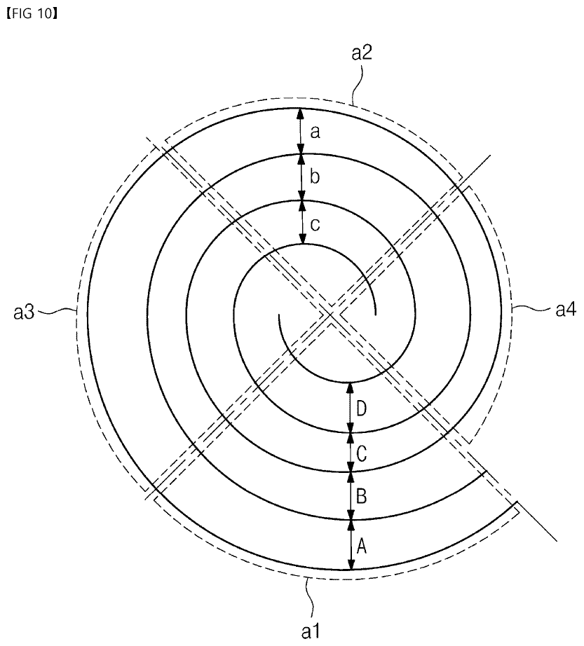

FIG. 9 illustrates a fourth embodiment of a wrap design scheme of a scroll compressor according to the present disclosure.

Rather than changing the wrap thickness, in the scroll compressor according to the present disclosure, the first envelope curve S1 and the second envelope curve S2 may be designed to be different from each other. The shapes of the first envelope curve S1 and the second envelope curve S2 may be designed to be different from each other based on overall configuration extending from the outermost end to the innermost end.

As the first envelope curve S1 and the second envelope curve S2 are designed by different mathematical formulas for each portion, even when certain partial areas thereof facing each other are designed by the same mathematical formula, other areas thereof facing each other—located inward or outward of those partial areas—may be designed by completely different mathematical formulas. For example, in the drawing, an area defined at an inner side of the first envelope curve S1 and an area defined at an outermost side of the second envelope curve S2 in a third area a3 may be formed in an arc shape and designed by the same shape or mathematical formula as each other. However, an area defined at an outermost side of the first envelope curve S1 may face the second envelope curve S2 formed in the arc shape, but may be formed in a logarithmic spiral or involute shape and may be designed by a shape or a mathematical formula different from that of the second envelope curve S2 formed in the arc shape.

For example, the first envelope curve SI may extend in the arc shape in at least one of a first area a1, defined within a 90-degree range about the rotation shaft from the outermost end thereof adjacent to the inlet 325, and the third area a3, defined within a 90-degree range about the rotation shaft from a distal end of the first area a1. However, the first envelope curve S1 may extend in the logarithmic spiral shape in at least one of a second area a2, defined within a 90-degree range about the rotation shaft from a distal end of the third area, and a fourth area a4, defined within a 90-degree range about the rotation shaft from a distal end of the second area.

The second area a2 may be an area defined symmetrical or opposite to the first area a1 with respect to a center 0 of the rotation shaft or the outlet 326.

As a result, the displacement volume may be further expanded compared to that when the first envelope curve S1 and the second envelope curve S2 are formed in the same shape. For example, the first envelope curve S1 and the second envelope curve S2 may be formed as a combination of the involute shape, the logarithmic spiral shape, and a circular shape. As a result, the first envelope curve S1 and the second envelope curve S2 may extend from the inlet 325 to the outlet 326 at different radii of curvature for each portion, so that the first envelope curve S1 and the second envelope curve S2 may be further expanded.

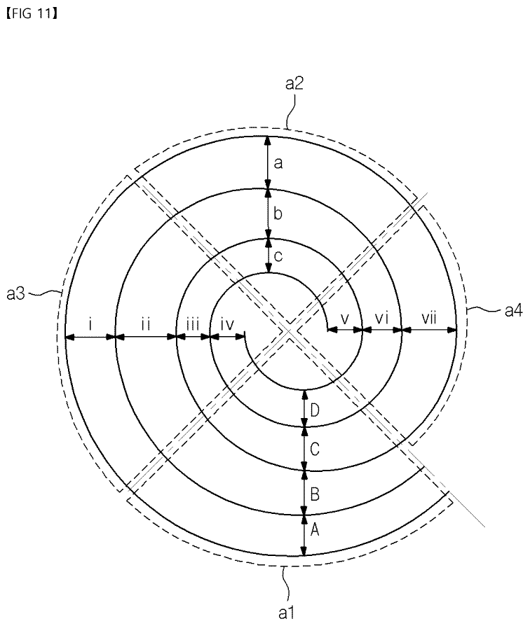

FIG. 10 illustrates a fifth embodiment of a wrap design scheme of a scroll compressor according to the present disclosure.

An outermost portion of the first area a1 corresponds to an area of the first envelope curve S1 and the second envelope curve S2 farthest from the center o, and an outermost portion of the fourth area a4 corresponds to an area of the first envelope curve S1 and the second envelope curve S2 closest to the center o.

Accordingly, the scroll compressor according to the present disclosure may expand the displacement volume by designing a spacing between the first envelope curve S1 and the second envelope curve S2 in the first area a1 to be greater than those in other areas.

For example, in the scroll compressor according to the present disclosure, spacings A, B, C, and D between respective pairs of adjacent portions of the first envelope curve S1 and the second envelope curve S2 in the first area a1 may be greater than spacings a, b, and c between respective pairs of adjacent portions of the first envelope curve S1 and the second envelope curve S2 in the second area facing the first area. Accordingly, an effect of further expanding the orbiting wrap 333 or the fixed wrap 323 from the center o to the outer circumferential surface of the orbiting end plate 331 in the first area a1 may be achieved, and an effect similar to that of the center o being eccentric to one side of the orbiting end plate 331 may be derived.

In addition, the spacings a, b, and c between the respective pairs of adjacent portions of the first envelope curve S1 and the second envelope curve S2 in the second area may be equal to each other. Accordingly, the displacement volume of the first area a1 may be further improved, thereby enhancing an overall ratio of expansion of the displacement volume.

In addition, in the first area a1, a spacing D between innermost portions of the first envelope curve SI and the second envelope curve S2 and a spacing A between outermost portions of the first envelope curve S1 and the second envelope curve S2 may be greater than at least one of spacings B and C between pairs of adjacent portions defined therebetween of the first envelope curve S1 and the second envelope curve S2.

As a result, the displacement volume may be further expanded compared to that when the orbiting wrap 333 and the fixed wrap 323 have a uniform spacing or are designed by the same mathematical formula in all areas.

FIG. 11 illustrates a sixth embodiment of a wrap design scheme of a scroll compressor according to the present disclosure.

In the present disclosure, the displacement volume may be expanded by designing the first envelope curve S1 and the second envelope curve S2 to have different spacings for each area. For example, a spacing between adjacent portions of the orbiting wrap disposed in the first area a1, defined within the 90-degree range about the rotation shaft from the outermost end of the orbiting wrap, may be different from at least one of a spacing between adjacent portions of the orbiting wrap disposed in the third area a3, defined within the 90-degree range about the rotation shaft from the distal end of the first area, a spacing between adjacent portions of the orbiting wrap disposed in the second area a2, defined within the 90-degree range about the rotation shaft from the distal end of the third area a3, and a spacing between adjacent portions of the orbiting wrap disposed in the fourth area a4, defined within the 90-degree range about the rotation shaft from the distal end of the second area a2.

In other words, the spacings A, B, C, and D between respective pairs of adjacent portions of the first envelope curve S1 and the second envelope curve S2 in the first area a1, defined in the first area a1 in an order from an outermost side to an inner side, may be different from at least one of spacings ┐, └, ⊏, and [symbol] between respective pairs of adjacent portions of the first envelope curve S1 and the second envelope curve S2, defined in the third area in an order from an outermost side to an inner side, spacings a, b, and c between respective pairs of adjacent portions of the first envelope curve S1 and the second envelope curve S2, defined in the second area in an order from an outermost side to an inner side, and spacings, [symbol] , [symbol] , and [symbol] between respective pairs of adjacent portions of the first envelope curve S1 and the second envelope curve S2, defined in the fourth area in an order from an outermost side to an inner side.

In the present disclosure, the displacement volume may be expanded by designing the spacing between the first envelope curve S1 and the second envelope curve S2 to vary for each area. For example, the spacing between the adjacent portions of the orbiting wrap disposed in the first area a1, defined within the 90-degree range about the rotation shaft from the outermost end of the orbiting wrap, the spacing between the adjacent portions of the orbiting wrap disposed in the third area a3, defined within the 90-degree range about the rotation shaft from the distal end of the first area, the spacing between the adjacent portions of the orbiting wrap disposed in the second area a2, defined within the 90-degree range about the rotation shaft from the distal end of the third area a3, and the spacing between the adjacent portions of the orbiting wrap disposed in the fourth area a4, defined within the 90-degree range about the rotation shaft from the distal end of the second area a2 may all be different from each other.

In other words, the spacings A, B, C, and D between respective pairs of adjacent portions of the first envelope curve SI and the second envelope curve S2, defined in the first area a1 in the order from the outermost side to the inner side, the spacings ┐, └, ⊏, and [symbol] between respective pairs of adjacent portions of the first envelope curve S1 and the second envelope curve S2, defined in the third area in the order from the outermost side to the inner side, the spacings a, b, and c between respective pairs of adjacent portions of the first envelope curve S1 and the second envelope curve S2, defined in the second area in the order from the outermost side to the inner side, and the spacings [symbol] , [symbol] , and [symbol] between respective pairs of adjacent portions of the first envelope curve S1 and the second envelope curve S2, defined in the fourth area in the order from an outermost side to the inner side may all be different from each other.

In one example, the spacing between the adjacent portions of the orbiting wrap disposed in the first area a1 may be greater than the spacing between the adjacent portions of the orbiting wrap disposed in the third area a3, and the spacing between the adjacent portions of the orbiting wrap disposed in the third area a3 may be greater than the spacing between the adjacent portions of the orbiting wrap disposed in the second area a2. As a result, by expanding the spacing between the outermost portions of the first envelope curve S1 and the second envelope curve S2 first, an area occupied by the entire envelope curves may be expanded, and the displacement volume may be increased compared to the same orbiting end plate area size.

The present disclosure may be modified and implemented in various forms, so that the scope of the rights may not be limited to the above-described embodiments. Therefore, when the modified embodiment includes the elements of the claims of the present disclosure, it should be regarded as belonging to the scope of the present disclosure.

1-15. (canceled)

16. A compressor comprising:
a casing;
a fixed scroll comprising:
a fixed end plate coupled to the casing and including an inlet configured to suck a refrigerant and an outlet disposed inwardly of the inlet and configured to discharge the refrigerant; and
a fixed wrap provided to protrude from one side of the fixed end plate and to extend from the inlet toward the outlet;
an orbiting scroll comprising:
an orbiting end plate disposed to face the fixed plate; and
an orbiting wrap extending from the orbiting end plate to face the fixed wrap and configured to compress the refrigerant; and
a driver including a rotation shaft rotatably supported on the orbiting end plate and configured to allow the orbiting end plate to orbit about the fixed end plate,
wherein in a first region corresponding to 90 degrees from the outer end of the orbiting wrap to the center of the rotation shaft, the spacing of the outermost part of the orbiting wrap and the spacing of the innermost part of the orbiting wrap are provided to be larger than the other spacings.

17. The compressor of claim 16, wherein the orbiting wrap is formed thicker than the fixed wrap.

18. The compressor of claim 16, wherein the orbiting wrap becomes thicker while extending from the inlet to the outlet.

19. The compressor of claim 16, wherein the orbiting wrap becomes thinner while extending from the inlet to the outlet.

20. The compressor of claim 16, wherein a spacing between adjacent portions of the orbiting wrap disposed in a first area, corresponding to a 90-degree range about the rotation shaft from an outermost end of the orbiting wrap facing the inlet, is set to be greater than a spacing between adjacent portions of the orbiting wrap disposed in other areas.

21. The compressor of claim 20, wherein spacings between respective pairs of adjacent portions of the orbiting wrap disposed in a second area, corresponding to a side opposite the first area with respect to the rotation shaft, are equal to each other.

22. The compressor of claim 20, wherein a spacing between adjacent portions of the fixed wrap facing the adjacent portions of the orbiting wrap disposed in the first area is set to be greater than a spacing between adjacent portions of the fixed wrap disposed in other areas.

23. The compressor of claim 21, wherein spacings between respective pairs of adjacent portions of the fixed wrap facing the respective pairs of adjacent portions of the orbiting wrap disposed in the second area are equal to each other.

24. The compressor of claim 16, wherein the orbiting wrap extends from an outermost end thereof facing the inlet to an innermost end thereof facing the outlet, and has a shape formed by a combination of an arc and a logarithmic spiral.

25. The compressor of claim 24, wherein the orbiting wrap extends in the arc shape from the outermost end thereof and then extends in the logarithmic spiral shape.

26. The compressor of claim 24, wherein the orbiting wrap extends from the outermost end thereof in the arc shape over 180 degrees with respect to the rotation shaft, and then extends in the logarithmic spiral shape over 90 degrees or more with respect to the rotation shaft.

27. The compressor of claim 24, wherein the orbiting wrap extends from the outermost end thereof in the arc shape over 180 degrees with respect to the rotation shaft, and extends in the logarithmic spiral shape in other areas.

28. The compressor of claim 16, wherein a spacing between adjacent portions of the orbiting wrap disposed in a first area, defined within a 90-degree range about the rotation shaft from an outermost end of the orbiting wrap adjacent to the inlet, is different from at least one of:
a spacing between adjacent portions of the orbiting wrap disposed in a third area, defined within a 90-degree range about the rotation shaft from a distal end of the first area;
a spacing between adjacent portions of the orbiting wrap disposed in a second area, defined within a 90-degree range about the rotation shaft from a distal end of the third area; and
a spacing between adjacent portions of the orbiting wrap disposed in a fourth area, defined between a distal end of the second area and the first area.

29. The compressor of claim 28, wherein the spacing between the adjacent portions of the orbiting wrap disposed in the first area, defined within the 90-degree range about the rotation shaft from the outermost end of the orbiting wrap adjacent to the inlet, the spacing between the adjacent portions of the orbiting wrap disposed in the third area, defined within the 90-degree range about the rotation shaft from the distal end of the first area, the spacing between the adjacent portions of the orbiting wrap disposed in the second area, defined within the 90-degree range about the rotation shaft from the distal end of the third area, and the spacing between the adjacent portions of the orbiting wrap disposed in the fourth area, defined between the distal end of the second area and the first area are all different from each other.

30. The compressor of claim 29, wherein the spacing between the adjacent portions of the orbiting wrap disposed in the first area is greater than the spacing between the adjacent portions of the orbiting wrap disposed in the third area, and the spacing between the adjacent portions of the orbiting wrap disposed in the third area is greater than the spacing between the adjacent portions of the orbiting wrap disposed in the second area.
